(19) United States
(12) Patent Application Publication
(10) Pub. No.: US 2006/0129603 A1
(43) Pub. Date: Jun. 15, 2006

(54) Apparatus and method for detecting malicious code embedded in office document

(76) Inventors: Jae Woo Park, Shinsung-Dong (KR); Won Ho Kim, Jeonmin-Dong (KR); Jung Hwan Moon, Shinsung-Dong (KR); Ki Wook Sohn, Jeonmin-Dong (KR)

Correspondence Address: LADAS & PARRY LLP, 224 SOUTH MICHIGAN AVENUE, SUITE 1600, CHICAGO, IL, 60604, US

(21) Appl. No.: 11/211,057

(22) Filed: Aug. 24, 2005

(30) Foreign Application Priority Data
Dec. 14, 2004 (KR) 2004-105521
May 25, 2005 (KR) 2005-044241

(51) Int. Cl. G06F 17/00

(52) U.S. Cl. 707/104.1

(57) ABSTRACT

An apparatus and method for detecting an unknown malicious code embedded in an office document are provided. The method includes the steps of: (a) when the office document is opened, previously checking whether or not the office document has an office document extension name, using a program for checking the malicious code in the office document; (b) determining whether or not the office document having the extension name has a macro function; (c) if it is determined from the determination result of the step (b) that the office document has the macro function, determining whether or not the office document has an execution code/whether or not the execution code is executable; (d) if it is determined from the determination result of the step (c) that the execution code is executable, detecting whether or not the malicious code is embedded in the office document; and (e) on the basis of the result of the step (d), determining whether or not the office document is executed.

### BACKGROUND OF THE INVENTION

1. Field of the Invention

The present invention relates to a malicious code detection method, and more particulatly, to an apparatus and method for detecting an unknown malicious code embedded in an office document of a Microsoft product family, which is being popularized for general purpose.

2. Description of the Related Art

In general, an office document of a Microsoft product family is being widely used in a document work, and a macro function is provided to all of the Microsoft product families for user's convenience. In a recent year, hackers embed a malicious code in the office document so that when a user opens the office document, they automatically install and make bad use of the embedded malicious code in a user computer, using the macro function. At present, domestic and foreign vaccines do not have a function of searching a document file, and employ a method for searching only an installed execution file or detecting a malicious code using a resident memory. Most vaccines use a pattern-based detection method, and cannot detect an unknown malicious code.

When a macro security provided from the office document itself is set to a maximal level so as to overcome the defect, there is a drawback in that since a macro of a normal document is notexecuted, the normal document cannot be opened. Also, there is a disadvantage in that it cannot be detected whether or not the normal document has the malicious code until a user executes the macro. Therefore, the malicious code cannot be executed and detected until the document is opened. Accordingly, a function for previously searching the malicious code before the opening of the document is being earnestly required. Until now, a method satisfying such a function does not have been known in the art.

In other words, until now, there does not exist a method for preventing or detecting the malicious code embedded in the office document of the Microsoft product family and unregistered to a given pattern. When the macro security is maximally set to the document having a normal macro function, the macro function is not performed, thereby causing a difficulty in normally opening the document. Also, the malicious code cannot be executed and detected prior to the opening of the document. The method for detecting the unknown malicious code before the opening of the document does not have been known.

### SUMMARY OF THE INVENTION

Accordingly, the present invention is directed to an apparatus and method for detecting a malicious code embedded in an office document, which substantially obviates one or more problems due to limitations and disadvantages of the related art.

It is an object of the present invention to provide an apparatus and method for detecting an unknown malicious code embedded in an office document before the office document is opened.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for detecting an unknown malicious code in an office document, the method including the steps of: (a) when the office document is opened, previously checking whether or not the office document has an office document extension name, using a program for checking the malicious code in the office document; (b) determining whether or not the office document having the extension name has a macro function; (c) if it is determined from the determination result of the step (b) that the office document has the macro function, determining whether or not the office document has an execution code/whether or not the execution code is executable; (d) if it is determined from the determination result of the step (c) that the execution code is executable, detecting whether or not the malicious code is embedded in the office document; and (e) on the basis of the result of the step (d), determining whether or not the original office program is executed.

The step (c) includes: an execution code existence or absence checking step of, if it is determined that the office document has the macro function, searching a whole office document file for an execution code format, and searching a character string of bytes corresponding to DOS MZ header to Portable executable (PE) header; and an execution code parsing step of checking the character string of DOS MZ header to PE header as to whether or not the character string of the searched execution code file format follows a PE format rule based on a PE file structure.

In another aspect of the present invention, there is provided an apparatus for detecting an unknown malicious code in an office document, the apparatus including: an office document extension name searching module for, when the office document is opened, checking whether or not the corresponding office document has an office document extension name; a macro detecting module for detecting whether or not the office document having the extension name has a macro function; and an execution code checking/parsing module for checking whether or not the office document having the macro function has an execution code, and checking whether or not the execution code is executable.

In the inventive detection method, when a user opens the office document, it is primarily checked whether or not the corresponding office document has the macro function, it is secondarily checked whether or not the office document has the executable malicious code, and if a code suspected to be the malicious code is detected, an alarm message is sent, and the office document is closed, thereby preventing a damage resulting from the malicious code.

In the inventive detection method of the malicious code embedded in the office document of the Microsoft product family, it is detected whether or not a file having the office document extension name has the document having the macro function, a whole office document file is searched for an executable file format, and the character string of the DOS MZ header to PE header is checked as to whether or not the character string follows the PE format rule based on a general PE file structure and as to whether or not the execution code is executable, so that when the two conditions are satisfied, it is detected that the malicious code is embedded in the corresponding office document.

Here, the PE is a basic file format of Win32. The PE format is branched from a Common Object File Format (COFF) of Unix, and the PE means a common use under a Win 32 platform, and all Win 32 execution files excepting VxD and 16 bits DLL use the PE file format, and a kernel of the NT is loaded using the PE file format.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a conceptive block diagram illustrating an apparatus for detecting a malicious code embedded in an office document according to an embodiment of the present invention; and

FIG. 2 is a flowchart illustrating a method for detecting a malicious code embedded in an office document according to an embodiment of the present invention.

### DETAILED DESCRIPTION OF THE INVENTION

Reference will now be made in detail to the preferred embodiments of the present invention, examples of which are illustrated in the accompanying drawings.

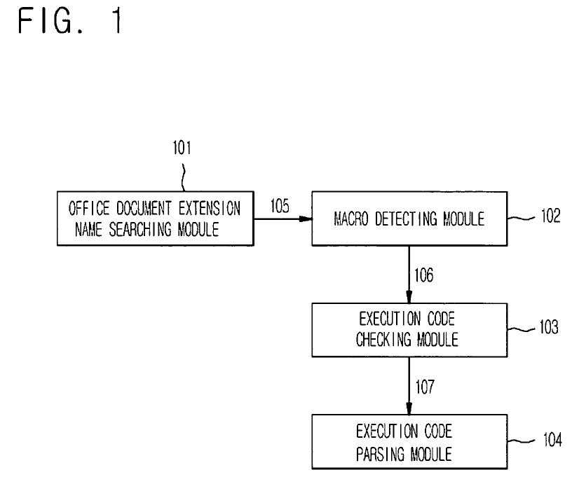

FIG. 1 is a conceptive block diagram illustrating an apparatus for detecting a malicious code embedded in an office document according to an embodiment of the present invention.

The inventive detection apparatus includes an office document extension name searching module 101, a macro detecting module 102, an execution code checking module 103, and an execution code parsing module 104.

The inventive program is Window application program, and exists in a user kernel space. All extension names of the office documents are connected to a Window registry and therefore, the inventive program is registered to all of the extension names of the office documents at an address of the connected Window registry so that when a user opens the document, the inventive program is first executed and activated to search for the office document extension name in the office document extension name searching module 101.

When the office document is opened, the inventive program first has a control for the corresponding office document (105). When the macro detecting module 102 does not detect a macro function in the corresponding office document, the inventive program passes the control to an original office program.

When the macro detecting module 102 detects the macro function embedded in the office document, the control is passed to the execution code checking module 103 (106). The execution code checking module 103 searches the corresponding office document for an execution file format, and passes a character string of bytes corresponding to DOS MZ header to PE header, to the execution code parsing module 104 (107). The execution code parsing module 104 follows a PE format rule based on the general PE file structure for the character string. The execution code parsing module 104 checks the character string of the DOS MZ header to PE header as to whether or not an execution code is executable. If it is checked that the execution code is executable, the execution code parsing module 104 detects that the malicious code is embedded, and the program ends.

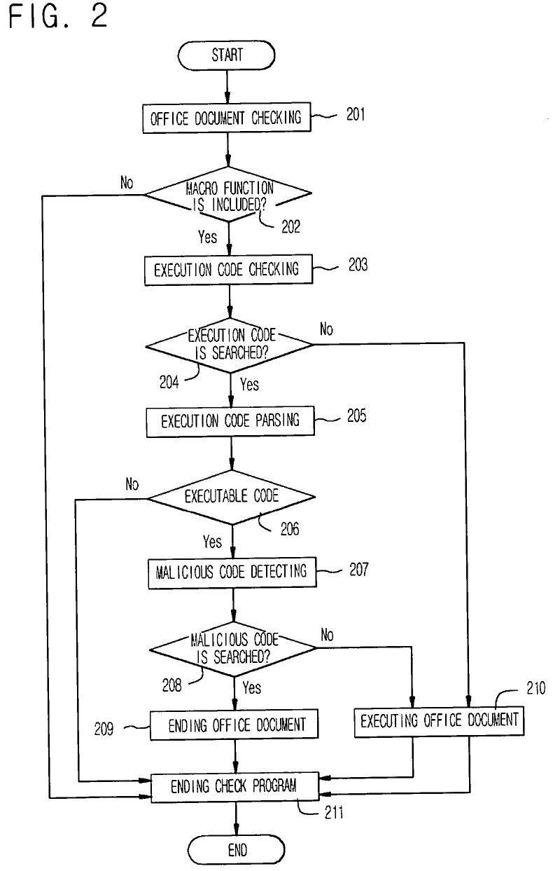

FIG. 2 is a flowchart illustrating a method for detecting the malicious code embedded in the office document according to an embodiment of the present invention. The inventive detailed operation is performed in each step.

First, when the user opens the office document, it is checked whether or not the office document has the office document extension name (Step 201), and it is detected whether or not the office document includes the macro function (Step 202).

If it is determined from the detection result that the office document has the macro function, it is checked whether or not the corresponding office document has the execution code (Step 203). If it is checked from the check result that the corresponding office document does not have the execution code (Step 204), the control is passed to the original program connected to the office document (Step 210) and then, the program ends (Step 211).

If the corresponding office document has the execution code (Step 204), an execution code parsing process starts (Step 205), and it is checked whether or not the execution code is executable within the corresponding office document (Step 206). If it is checked from the check result that the execution code is executable, the malicious code is detected from the corresponding office document (Step 207). If the malicious code is detected, the user is notified that the malicious code is detected, the office document is not executed (Step 209), and then, the program ends (Step 211).

As described above, the inventive method overcomes a defect of a conventional pattern-based detection method, and provides an effect in that when all office-series documents are opened, the unknown malicious code can be effectively detected, a user's intermediate intervention is not required, and it can be inserted as an additional function to a conventional vaccine without any trouble on a function of the conventional vaccine.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for detecting an unknown malicious code in an office document, the method comprising the steps of:
(a) when the office document is opened, previously checking whether or not the office document has an office document extension name, using a program for checking the malicious code in the office document;
(b) determining whether or not the office document having the extension name has a macro function;
(c) if it is determined from the determination result of the step (b) that the office document has the macro function, determining whether or not the office document has an execution code/whether or not the execution code is executable;
(d) if it is determined from the determination result of the step (c) that the execution code is executable, detecting whether or not the malicious code is embedded in the office document; and
(e) on the basis of the result of the step (d), determining whether or not the office document is executed.

2. The method of claim 1, wherein the step (c) comprises:
an execution code existence or absence checking step of, if it is determined that the office document has the macro function, searching a whole office document file for an execution code format, and searching a character string of bytes corresponding to DOS MZ header to Portable executable (PE) header; and
an execution code parsing step of checking the character string of DOS MZ header to PE header as to whether or not the character string of the searched execution code file format follows a PE format rule based on a PE file structure.

3. The method of claim 1, wherein in the step (c), if it is determined that the office document does not have the macro function, the program ends.

4. The method of claim 1, wherein in the step (d), if it is determined that the execution code is executable, it is determined that the corresponding office document has the malicious code, a user is notified that the corresponding office document has the malicious code, and the program ends.

5. The method of claim 1, wherein in the step (e), if it is determined that the office document has the malicious code, the office document is not executed, and the program ends.

6. The method of claim 1, wherein in the step (e), if it is determined that the office document does not have the malicious code, the office document is executed, and the program ends.

7. The method of claim 1, wherein in the step (e), if it is determined that the office document has the malicious code, an alarm message is sent, and the office document program ends.

8. An apparatus for detecting an unknown malicious code in an office document, the apparatus comprising:
an office document extension name searching module for, when the office document is opened, checking whether or not the corresponding office document has an office document extension name;
a macro detecting module for detecting whether or not the office document having the extension name has a macro function; and
an execution code checking/parsing module for checking whether or not the office document having the macro function has an execution code, and checking whether or not the execution code is executable.

9. The apparatus of claim 8, wherein the execution code checking/parsing module comprises:
an execution code checking module for searching the office document having the macro function for an execution code format, and providing a character string of bytes corresponding to DOS MZ header to PE (Portable Executable) header, for the execution code parsing module; and
an execution code parsing module for checking the character string of the DOS MZ header to PE header as to whether or not the execution code is executable, and if it is checked that the execution code is executable, detecting that the malicious code is embedded, and ending the program.
